(19) United States
(12) Patent Application Publication
(10) Pub. No.: US 2026/0269770 A1
(43) Pub. Date: Sep. 10, 2026

(54) VERTICAL PHOTOVOLTAIC SYSTEM AND METHOD FOR INSTALLING SUCH A SYSTEM

(71) Applicant: ENGIE, Courbevoie (FR)

(72) Inventor: Luc BARROVECCHIO, Courbevoie (FR)

(21) Appl. No.: 19/106,650

(22) PCT Filed: Sep. 5, 2023
(86) PCT No.: PCT/EP2023/074330

§ 371 Date: Feb. 26, 2025

(30) Foreign Application Priority Data
Sep. 6, 2022 (FR) FR2208912

(51) Int. Cl. H02S 20/10

(52) U.S. Cl. CPC H02S 20/10

(57) ABSTRACT

The vertical photovoltaic system (100), which comprises at least one photovoltaic module (105) and two posts (110, 111), comprises at least:

for each post, a primary securing means (115) for securing a first flexible tie (120) to said post, the collaboration between the primary securing means applying longitudinal tension to the first tie,

the first flexible tie being held taut between the two posts, and

a fixing means (125) for fixing the module to the tie.

### TECHNICAL FIELD OF THE INVENTION

The present invention relates to a vertical photovoltaic system wherein a module is fixed on a tie, such as a cable, and a method for installing such a system. It applies, in particular, to the field of the production of energy from renewable sources.

### STATE OF THE ART

In the field of the production of energy from renewable sources, the use of photovoltaic systems is an effective solution for transforming light energy into electrical energy. However, the installation of such systems must take certain constraints present in and dependent on the installation site into account. These constraints can be defined, in particular according to the surface area, topography, nature and use of the installation site.

In certain locations that could accommodate photovoltaic systems, there is a problem of space, especially with respect to agricultural lands. These sites therefore need to be shared between agriculture and the production of energy. When this distribution is effective then coactivity is established, corresponding to the coexistence between a major agricultural activity and an efficient production of energy by photovoltaic systems. This coactivity is referred to as “agrivoltaism”, also known as “Agri-PV” or “APV”.

The solutions of the prior art describe photovoltaic systems using cables to support the modules. However, these systems present in particular horizontal modules, i.e. substantially parallel to the installation surface, inclined and/or elevated above agricultural crops. These solutions do not take into consideration the need to reduce the footprint of the photovoltaic systems. Consequently, these systems have limited compatibility with sites with intense spatial constraints, and therefore with agrivoltaism. Moreover, such systems using cables are not optimised for bifacial modules and have shadowing on the module while the system is being used, and therefore a reduction in the solar radiation irradiating the module. In this way, the production of electricity by these systems is not optimal.

In addition, other solutions of the prior state of the art describe photovoltaic systems that require a significant amount of materials such as steel or aluminium. Such systems consequently have ecological and economic impacts to be improved. Additionally, in the prior state of the art, the profiles used that require a significant amount of material notably cast a shadow on the module while the system is being used. Such a shadow causes, in particular, a reduction in the solar radiation irradiating the module and therefore has a negative impact on the production of energy by the system.

The following are known:
European patent application EP 2 669 596, which discloses a system with suspended photovoltaic panels,
U.S. Pat No. 8,448,390, which discloses a system of photovoltaic panels inclined to absorb the sun's rays, and
German utility certificate application DE 20 2020 104 397, which discloses vertical photovoltaic panels mounted on rigid cables.

### DESCRIPTION OF THE INVENTION

The present invention aims to remedy all or part of these drawbacks.

To this end, according to a first aspect, the present invention envisions a vertical photovoltaic system according to claim 1.

Thanks to these provisions, the system makes it possible to minimise the costs of the materials and components required for the installation, for example by eliminating some elements commonly used because of mechanical stresses. Such elements are, for example, horizontal beams. The elimination of such elements makes it possible, in particular, to reduce the quantity, for example, of metal required by the system. In addition, the system is compatible with, for example, the use of several modules that can be fixed and suspended on the first tie in a similar way to the first module. The number of posts initially used to support these modules is therefore reduced, thus making it possible to limit the cost of materials. In addition, such a reduction in materials improves the system's environmental performance, in particular by reducing the energy required to manufacture the elements required for the installation.

Moreover, these provisions, in conjunction with a reduction in the elements required for the installation of a system, make it possible to reduce the shadows on one or more active faces of the module. For example, when the module is bifacial, the shadows are reduced on the back face of the module. Such a reduced shadow makes it possible to increase the amount of electrical energy produced by the photovoltaic module from solar energy. In this way, the production of electrical energy is optimised.

In addition, the system also makes it possible to reduce the footprint, and in particular to increase compatibility with agricultural activity on the installation land. This system is therefore compatible with agrivoltaism. The system thus installed also has a low hydrological impact on the plants when it is installed on agricultural land.

In addition, the system is modular and therefore enables a simplified, rapid and flexible installation. For example, securing the tie is easy when the posts are installed, and fixing the module to the tie is subsequently rapid and easy. Thus, the system can be easily adapted to the constraints inherent in the installation site and the constraints on use. For example, such a system is easily installed on a site with a slope. Furthermore, the replacement of a part or module, e.g. when damaged, is facilitated since all or part of the system can be easily and quickly disassembled and reassembled. Thus, when one section of the installation is damaged, the specific replacement of this section can be carried out without the rest of the installation having to be disassembled.

In addition, these provisions mean the system can be disassembled easily. In particular, when the energy exploitation of the system ends, the disassembly is carried out with limited damage to the installation site, allowing the installation site to return to its previous condition without installation.

These provisions also make it possible to use a considerable variety of photovoltaic modules, for example having different sizes or a specific organisation of the cell lines.

In addition, the use of a tie in the system and the adaptability of the fixing means mean that the edge of the module can be positioned at varying distances from the two posts, for example according to the shadow which the posts generate. For example, if a post is to the south of the photovoltaic module at a first distance, such a module can be positioned at a second distance from the other post to the north of the module, the second distance being less than the first distance.

Lastly, the system has significant stability and mechanical resistance, enabling continuity of exploitation for many years.

In some optional embodiments, the fixing means comprises a housing at least partially enclosing a first tie.

Thanks to these provisions, the at least partial enclosure of the fixing means around the first tie makes it possible to increase the contact surface between these two elements. Thus, the fixing of the module to the first tie has improved stability and robustness, in particular playing a role in maintaining the position of the suspended module in the photovoltaic system.

In some optional embodiments, the fixing means traverses at least partially a first tie.

Thanks to these provisions, the fixing means traverses the structure of the tie, making it possible to reinforce the fixing of the module to the tie and the stability of the suspended module.

In some optional embodiments, the module is rectangular and delimited by at least one side, and the tie extends at the location of this side.

Thanks to these provisions, the verticality of the system is easily maintained without imposing specific mechanical stresses on the module or on an element of the system. In addition, when the module is bifacial, the tie does not extend behind the module, thus reducing the shadow on an active face of the module. In this way, the production of electrical energy is optimised.

In some optional embodiments, the system also comprises:
for each post, a secondary securing means for securing a second flexible tie to said post, the collaboration between the secondary securing means applying longitudinal tension to the second tie, and
the second flexible tie being held taut between the two posts.

The first tie and the second tie are secured to two different parts of the photovoltaic module.

Thanks to these provisions, the use of a second cable makes it possible to improve the stability of the system and also to increase the system's compatibility with installation sites that have significant mechanical stresses, such as the presence of wind.

In some optional embodiments, a fixing means for fixing the photovoltaic module to the tie comprises a fixing mount for fixing the photovoltaic module.

In some optional embodiments, a fixing means for fixing the photovoltaic module to the tie also comprises an intermediate fixing element separate from the fixing mount and connected to the fixing mount by a connecting means.

Thanks to these provisions, the system makes it possible for the fixing mount not to be fixed directly to the tie, thus allowing the mechanical stresses to be distributed. In addition, such a system makes it possible, for example, to use an intermediate element that is adaptable and easily modifiable according to the modules used. In particular, such an element can be connected to a fixing mount for fixing the module corresponding to a standard frame. In this way, the system's adaptability to standard modules is increased.

In some optional embodiments, the system comprises:
at least a first tie and a second tie,
at least two photovoltaic modules, and
for each said module, a fixing mount delimiting one face of the module.

The fixing mount for fixing a module also comprises at least one opening partially surrounding the tie and configured to receive the fixing mount for fixing the other photovoltaic module with this tie.

Thanks to these provisions, the system enables the complementarity of the two means for fixing two modules on a single cable. A vertical alignment of the two modules is therefore achieved. In this way, the organisation of the modules, especially the arrangement of one module relative to the other, is optimised with no loss of space at the level of the system.

In some optional embodiments, the fixing means has at least one portion forming a bevel oriented towards an active face of the photovoltaic module.

Thanks to these provisions, the system makes it possible to facilitate the passage of the light irradiating one or more active faces of the photovoltaic module. In addition, a bevel on the lower portion of the photovoltaic module makes it possible to avoid the accumulation of rain or residues that can, in particular, be responsible for a malfunction and/or premature wear of the module.

In some optional embodiments, the fixing means comprises an adjustment means configured to position at least one active face of the photovoltaic module closer to or farther from the tie being held taut between the two posts.

Thanks to these provisions, the adjustment means makes it possible to adjust the distance from or closeness to an active face of the module based on certain constraints so as to, for example:
reduce the shadows on the active face of the module, and/or
when two modules are comprised in the system, make it easier for the wind to pass between these two modules.

In some optional embodiments, at least one fixing means comprises a fixing hook or a fixing clamp.

Thanks to these provisions, the curve of the hook allows savings of material compared to angular shapes. In addition, a fixing hook limits the sliding, and therefore the separation, of the module from the system. A fixing clamp allows the tie to be enclosed, thus ensuring its immobilisation.

In some optional embodiments, the system also comprises at least one anchoring means for anchoring at least one tie in an installation ground, the collaboration between said anchoring means and the securing means applying supplementary longitudinal tension to the tie.

Thanks to these provisions, in addition to a secure attachment with the posts anchored in the installation ground the tie has an additional secure attachment with the anchoring means, incorporated directly into the installation ground. This improves the mechanical resistance of the system.

In some optional embodiments, at least one post comprises a said securing means for securing a tie.

Thanks to these provisions, the system make it easier to position the tie directly on the post, with no intermediate part. Such a positioning can also be modified according to the arrangement of the securing means comprised in the post. Thus, the system features flexibility of installation, especially when the installation site comprises specific topographical constraints such as steep slopes.

In addition, when there are several securing means on the post and the system comprises several photovoltaic modules, a single post can be used for these different modules. In this way, the number of posts to be used in the system is reduced.

In addition, such a securing means comprised in a post is compatible with the various profiles of posts that can be obtained according to various manufacturing methods.

In some optional embodiments, at least one securing means comprises an intermediate part for securing a post to a tie.

Thanks to these provisions, the system makes it possible to adapt the nature and/or arrangement of the intermediate part during the installation, in particular according to the desired height of the tie or the shape of the tie.

According to a second aspect, the present invention envisions a method for installing a cable-supported vertical photovoltaic system, according to claim 14.

As the particular aims, advantages and features of the method that is the subject of the present invention are similar to those of the device that is the subject of the present invention, they are not repeated here.

### BRIEF DESCRIPTION OF THE FIGURES

Other advantages, aims and particular features of the invention will become apparent from the non-limiting description that follows of at least one particular embodiment of the system and method that are the subjects of the present invention, with reference to drawings included in an appendix, wherein:

FIG. 1 represents, schematically, in a front view, a first particular embodiment of the system that is the subject of this invention,

FIG. 2 represents, schematically, in a top view, a second particular embodiment and a third particular embodiment of the system that is the subject of this invention, designated respectively by a) and b); in the rest of the description these embodiments are referenced 2-a) and 2-b),

FIG. 3 represents, schematically, a particular embodiment of a post, tie and securing means assembly, in a front view, in cross-section and in a side view, designated respectively by a1), a2) and a3); in the rest of the description the views of this embodiment are referenced 3-a1), 3-a2) and 3-a3),

FIG. 4 represents, schematically, in a side view, a second particular embodiment and a third particular embodiment, designated respectively by a) and b), of a post, tie and securing means assembly; in the rest of the description these embodiments are referenced 4-a) and 4-b),

FIG. 5 represents, schematically, a fourth particular embodiment of a post, tie and securing means assembly, in a front view, in cross-section and in a side view, designated respectively by a1), a2) and a3); in the rest of the description the views of this embodiment are referenced 5-a1), 5-a2) and 5-a3),

FIG. 6 represents, schematically, in a side view and in cross-section, seven particular embodiments, designated respectively by a), b), c), d), e), f) and g), of an element of a securing means and a tie; in the rest of the description the views of this embodiment are referenced 6-a), 6-b), 6-c), 6-d), 6-e), 6-f) and 6-g),

FIG. 7 represents, schematically, a particular embodiment of a post, tie and securing means assembly, in a front view designated by a1) and in cross-section designated by a2); the views of this embodiment are referenced 7-a1) and 7-a1),

FIG. 8 represents, schematically, in a top view and in cross-section, fifteen particular embodiments, designated respectively by a), b), c), d), e), f), g), h), i), j), k), 1), m), n) and o), of a post and tie assembly; in the rest of the description these embodiments are referenced 8-a), 8-b), 8-c), 8-d), 8-e), 8-f), 8-g), 8-h), 8-i), 8-j), 8-k), 8-1), 8-m), 8-n) and 8-o),

FIG. 9 represents, schematically in a front view, a particular embodiment of a module, tie and fixing means assembly,

FIG. 10 represents, schematically in a front view, a particular embodiment of a module, tie and fixing means assembly,

FIG. 11 represents, schematically in a front view, a particular embodiment of a module, tie and fixing means assembly,

FIG. 12 represents, schematically, in a side view and in cross-section, four particular embodiments, designated respectively by a), b), c) and d), of a module, tie and fixing means assembly comprising a fixing mount; in the rest of the description these embodiments are referenced 12-a), 12-b), 12-c) and 12-d),

FIG. 13 represents, schematically, in a side view and in cross-section, three particular embodiments, designated respectively by a), b) and c), of a module, tie and fixing means assembly comprising a fixing mount; in the rest of the description these embodiments are referenced 13-a), 13-b) and 13-c),

FIG. 14 represents, schematically, in a side view and in cross-section, seven particular embodiments, designated respectively by a), b), c), d) and e), of a module, tie and fixing means assembly comprising a fixing mount; in the rest of the description the views of this embodiment are referenced 14-a), 14-b), 14-c), 14-d) and 14-e),

FIG. 15 represents, schematically, in a side view and in cross-section, seven particular embodiments, designated respectively by a), b), c), d), e), f) and g), of a module, tie and fixing means assembly comprising an intermediate securing element; in the rest of the description these embodiments are referenced 15-a), 15-b), 15-c), 15-d), 15-e), 15-f) and 15-g),

FIG. 16 represents, schematically, in a side view and/or in a front view, a particular embodiment of a module, tie and fixing means assembly comprising an intermediate securing element, according to a two-step sequence of securing, designated by a1) prior to the securing and a2) and a2′) after the securing; in the rest of the description these sequences are referenced 16-a1), 16-a2) and 16-a2′),

FIG. 17 represents, schematically, in a front view and/or in a side view, a particular embodiment of a module, tie and fixing means assembly comprising an intermediate securing element, according to a two-step sequence of securing, designated by a1) and a1′) prior to the securing and a2) and a2′) after the securing; in the rest of the description these sequences are referenced 17-a1), 17-a1′), 17-a2) and 17-a2′),

FIG. 18 represents, schematically, in a front view and/or in a side view, a particular embodiment of a module, tie and fixing means assembly comprising an intermediate securing element, according to a two-step sequence of securing, designated by a1) and a1′) prior to the securing and a2) and a2′) after the securing; in the rest of the description these sequences are referenced 18-a1), 18-a1′), 18-a2) and 18-a2′),

FIG. 19 represents, schematically, in a front view and in a side view, designated respectively by a1) and a2), a particular embodiment of a module, tie and fixing means assembly comprising an adjustment means; in the rest of the description these embodiments are referenced 19-a1) and 19-a2),

FIG. 20 represents, schematically, in a front view and in a side view, designated respectively by a1) and a2), a particular embodiment of a module, tie and fixing means assembly comprising an adjustment means; in the rest of the description these embodiments are referenced 20-a1) and 20-a2),

FIG. 21 represents, schematically, in a front view and in a side view, designated respectively by a1) and a2), a particular embodiment of a module, tie and fixing means assembly comprising an adjustment means; in the rest of the description these embodiments are referenced 21-a1) and 21-a2),

FIG. 22 represents, schematically, in a side view and in a front view, designated respectively by a1) and a2), a particular embodiment of a tie and fixing means assembly; in the rest of the description the views of these embodiments are referenced 22-a1) and 22-a2), and

FIG. 23 represents, schematically and in the form of a logic diagram, a particular series of steps of the method that is the subject of the present invention.

### DESCRIPTION OF THE EMBODIMENTS

The present description is given in a non-limiting way, in which each characteristic of an embodiment can be combined with any other characteristic of any other embodiment in an advantageous way.

The indefinite articles “one” or “a”, as used in the description and in the claims, must be understood as meaning “at least one”, except when the contrary is clearly indicated.

The expression “and/or”, as it is used in the present document and in the claims, must be understood as meaning “one or other, or both” of the elements thus connected, i.e. elements that are present conjunctively in some cases and disjunctively in other cases. The multiple elements listed with “and/or” must be interpreted in the same way, i.e. “one or more” of the elements thus connected. Other elements can possibly be present, other than the elements specifically identified by the clause “and/or”, whether or not they are linked to these specifically identified elements. Therefore, as a non-limiting example, a reference to “A and/or B”, when it is used in conjunction with open-ended language such as “comprising”, can refer, in one embodiment, to A only (possibly including elements other than B); in another embodiment, to B only (possibly including elements other than A); in yet another embodiment, to A and B (possibly including other elements); etc.

As used here in the description and in the claims, “or” must be understood as having the same meaning as “and/or” as defined above. For example, when separating elements in a list, “or” or “and/or” must be interpreted as being inclusive, i.e. the inclusion of at least one, but also of more than one, of a number or a list of elements, and, optionally, of additional elements not listed. Only the terms clearly indicating the contrary, such as “only one of” or “exactly one of”, or, when they are used in the claims, “consisting of”, refer to the inclusion of a single element of a number or a list of elements. In general, the term “or” as it is used here must only be interpreted as indicating exclusive alternatives (i.e. “one or the other, but not both”) when it is preceded by exclusivity terms, such as “either”, “one of”, “only one of”, or “exactly one of”.

As used here in the present description and in the claims, the expression “at least one”, in reference to a list of one or more elements, must be understood as meaning at least one element chosen from among one or more elements in the list of elements, but not necessarily including at least one of each element specifically listed in the list of elements and not excluding any combination of elements in the list of elements. This definition also allows the optional presence of elements other than the elements specifically identified in the list of elements to which the expression “at least one” refers, whether or not they are linked to these specifically identified elements. Therefore, as a non-limiting example, “at least one of A and B” (or, equivalently, “at least one of A or B” or, equivalently, “at least one of A and/or B”), can refer, in one embodiment, to at least one, possibly including more than one, A, with no B present (and possibly including elements other than B); in another embodiment, to at least one, possibly including more than one, B, with no A present (and possibly including elements other than A); in yet another embodiment, to at least one, possibly including more than one, A and at least one, possibly including more than one, B (and possibly including other elements); etc.

In the claims, and also in the description below, all the transitive expressions such as “comprising”, “including”, “bearing”, “having”, “containing”, “involving”, “made of”, “formed of” and others, must be understood as being open, i.e. meaning including, but not limited to. Only the transitive expressions “consisting of” and “consisting essentially of” must be understood as closed or semi-closed expressions, respectively.

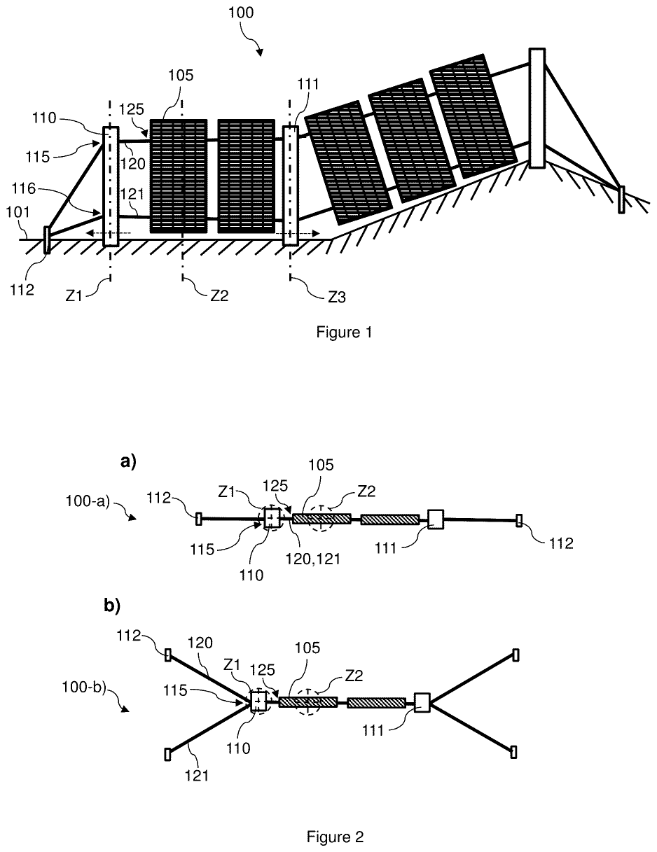

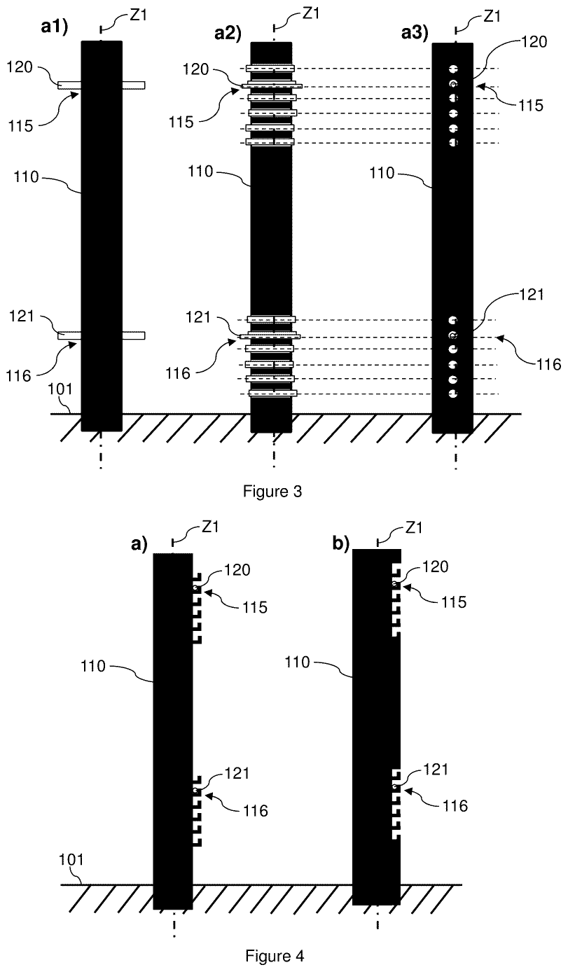

Throughout the description, the term “upper” or “top” refers to being located at the top in FIGS. 1, 3 to 5, 7 and 9 to 21, which correspond to the normal configuration of use of the system, and “bottom” or “lower” to being located at the bottom in these FIGS. 1, 3 to 5, 7 and 9 to 21. The term “behind” refers to being located behind the plane of the FIGS. 1, 3-a1), 5-a1), 9, 10, 11, 16-a2′), 17-a1), 17-a2), 18-a1), 18-a2), 19-a1), 20-a1) and 21-a1), and “in front” to being located in front of the plane of the figures. The notions of vertical and horizontal flow from these definitions.

The following definitions are noted here:

The term “increased electricity production” refers to an increase in the production of electricity, for example due to a larger amount of solar energy reaching the photovoltaic cells of the module.

The term “bifacial module” refers to a module producing electricity on both of its faces. The faces of a module are the two surfaces having the largest dimension. A bifacial module allows the light on its front face and its back face to be transmitted to its photovoltaic cells. The photovoltaic cells use the light on both of their faces to produce electricity. In other words, a bifacial module has two active faces. In general, there is at least one junction box on the back face of the module, and the power generated by the back face is usually less than the power generated by the front face. The term “installation surface” refers to a surface on which a photovoltaic system is installed. For example, such a surface refers to an installation ground. For example, the installation ground of the photovoltaic system is agricultural land.

The term “facing the installation ground” refers to an installation configuration in which one side of the photovoltaic module, for example a short side, is closer to the installation ground than the other, opposite, side of the photovoltaic module, when the photovoltaic module is rectangular.

The term “tie” refers to an element configured to connect at least two different and separated posts. Such a connection is achieved by the tie being placed under tension when the tie is secured to the posts. For example, the term ‘tie’ includes all cables, ropes and chains. A tie can be metallic or non-metallic. In particular, such a tie has a mechanical resistance that is sufficient to allow a module to be suspended and adaptable according, for example, to the mass of the photovoltaic module and mechanical stresses imposed by and/or on the system.

The term “flexible” refers to an element able to be deformed and to be placed under tension, under the effect of a mechanical stress, without breaking.

It is now noted that the figures are not to scale.

FIG. 1, which is not to scale, shows a schematic view of an embodiment of the system 100 that is the subject of the present invention. The system 100 is vertical and comprises a photovoltaic module 105 and two posts, 110 and 111. Such a system 100 also comprises at least:
for each post, 110 and 111, a primary securing means 115 for securing a first flexible tie 120 to the post,
the first flexible tie 120 being held taut between the two posts, 110 and 111, and
a fixing means 125 for fixing the module to the first tie.

It is noted that the system 100 shown in FIG. 1 has:
a vertical plane, perpendicular to the plane of FIG. 1, extending longitudinally to a post 110 and including the centre of a post 110,
a vertical plane, perpendicular to the plane of FIG. 1, extending longitudinally to another post 111 and including the centre of this other post 111, and
a vertical plane, perpendicular to the plane of FIG. 1 and including the centres of the two sides, top and bottom, of a rectangular photovoltaic module 105.

In particular, in FIG. 1, the intersections of the plane of FIG. 1 and these vertical planes define axes Z1, Z2 and Z3, respectively referred to as the axis Z1 of a post 110, axis Z3 of another post 111, and axis Z2 of a photovoltaic module 105. The axes Z1, Z2 and Z3 are therefore vertical, and thus the term vertical posts is used.

In some embodiments, such as that shown in FIG. 1, the straight lines representing the axes Z1, Z2 and Z3 are substantially parallel and coplanar. In other words, axes Z1, Z2 and Z3 are substantially parallel and coplanar.

In these embodiments, the following planes are not distinct, and correspond to the plane of FIG. 1:
the plane including the axes Z1 and Z3 of two consecutive posts, 110 and 111, and
the plane including the axis Z2 and formed by the face of at least one module 105 between these two posts, 110 and 111.

The term “vertical photovoltaic system” refers to a system in which the faces of photovoltaic modules are substantially vertical and the posts have substantially vertical axes. In other words, the surface defined by one of the faces of a vertical photovoltaic module comprises a vertical axis.

In some variants (not shown), the intersections of the plane of FIG. 1 and the two vertical planes of the posts, 110 and 111—these vertical planes being defined similar to the preceding embodiment-define axes Z1 and Z3, respectively referred to as the axis Z1 of a post 110 and the axis Z3 of another post 111. In these variants, the axis Z2 of a photovoltaic module 105 is defined by the intersection between:
the vertical plane including the centres of the two short sides of the rectangular photovoltaic module 105, and
the plane formed by the face of at least one module 105 between these two posts, 110 and 111.

In these variants (not shown), the following planes are distinct:
the plane including the axes Z1 and Z3 of two consecutive posts, 110 and 111, and
the plane including the axis Z2 and formed by the face of at least one module between these two posts.

In these variants (not shown), it is noted that the angle formed by these two planes, one plane including the axes Z1 and Z3 and the other plane including the axis Z2, is called the “angle of inclination of the photovoltaic module relative to the posts”. Preferably, such an angle of inclination is less than 12 degrees. Even more preferably, such an angle is less than 5 degrees.

In some embodiments, the two posts, 110 and 111, are identical, for example constituted of the same material, have the same height, and/or have an identical cross-sectional profile. In some variants, the two posts, 110 and 111, are different, for example constituted of a different material, respectively have a different height, and/or have a different cross-sectional profile. It is noted that the cross-sectional profile of a post corresponds to the shape delimited by the post according to a plane perpendicular to the axis of the post Z1. Examples of cross-sectional post profiles, 8-a), 8-b), 8-c), 8-d), 8-e), 8-f), 8-g), 8-h), 8-i), 8-j), 8-k), 8-1), 8-m), 8-n) and 8-o), are shown in FIG. 8. It is noted that, for example, when the system comprises a plurality of posts and photovoltaic modules, the posts at the ends of the system are preferably reinforced relative to the other posts arranged inside the system. Such a reinforcement gives the system improved mechanical resistance. Preferably, all the posts are compatible with each other, i.e. the posts can comprise, for example, common ties. For example, the posts on the edges of the installation have profiles with dimensions larger than the other posts in order for technico-economic and environmental optimisation. Preferably, a minimum of material, necessary to ensure the lifespan of the installation and its safety, is used.

It is noted that the separation between and height of the two posts, 110 and 111, are determined, for example, based on several parameters, including weather conditions, such as the presence of wind on the installation site, the material and dimensions of the tie, but are also based on the dimension, mass and number of photovoltaic modules 105 to be installed.

It is noted that, preferably, the nature of the photovoltaic module 105 is compatible with outdoor use. An outside environment defines, for example, thermal, mechanical, humidity or radiation constraints. For example, the photovoltaic module 105 is installed on agricultural land. The nature of such a photovoltaic module 105 is known to the person skilled in the art.

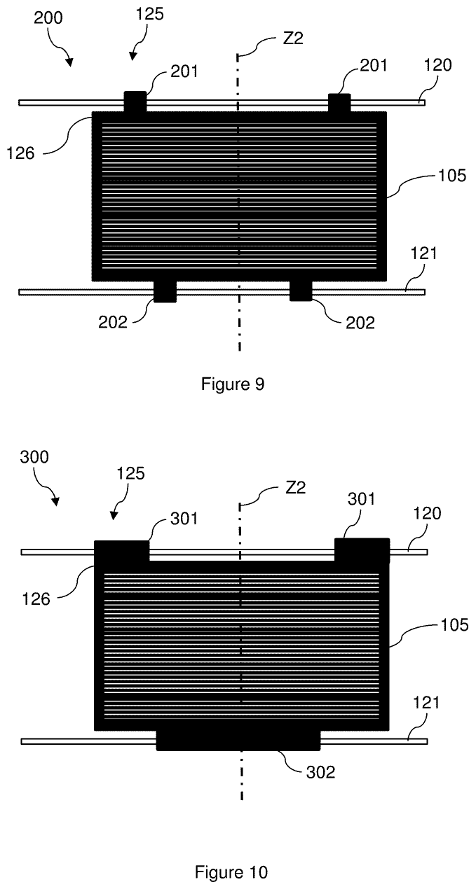

FIGS. 9, 10 and 11 show respective variants, 200, 300 and 400, of the photovoltaic system 100 shown in FIG. 1. In these figures, the two posts and the securing means are not shown.

In some embodiments, such as those shown in FIGS. 1, 9, 10 and 11, at least one photovoltaic module 105 is rectangular. In these embodiments, the rectangular module 105 is delimited by at least one side, and in particular four sides.

In some embodiments, such as those shown in FIGS. 1, 9, 10 and 11, a rectangular photovoltaic module 105 has two sides, called long sides, having a length that is greater than a length of at least two other sides, called short sides. In some variants (not shown), at least one photovoltaic module 105 is rectangular and has equal sides, thus forming a square.

In some embodiments, such as that shown in FIG. 1, at least one rectangular photovoltaic module 105 is fixed by a short side to a first tie 120. In other words, the installed photovoltaic module 105 is in “portrait” mode.

In some embodiments, such as those shown in FIGS. 9, 10 and 11, at least one rectangular photovoltaic module 105 is fixed by a long side to a first tie 120. In other words, the installed photovoltaic module 105 is in “landscape” mode. It is noted that, in these embodiments, the fixing of a photovoltaic module 105 by a long side makes it possible to provide the module 105 with support and therefore to increase the mechanical resistance of the photovoltaic module 105. In this way, the durability of the system is improved. This durability is improved even more when photovoltaic modules 105 are combined with fixing mounts corresponding to frames.

In some embodiments, such as those shown in FIGS. 9, 10 and 11, a first tie 120 extends at the location of a side of a rectangular photovoltaic module 105. In other words:
the first tie 120 and the side of the photovoltaic module 105 are parallel and preferably belong to the same plane defining the verticality of a photovoltaic system, 200, 300 and 400, and
the first tie 120 is arranged above the side of the photovoltaic module 105.

In other embodiments, when a photovoltaic system comprises a plurality of rectangular photovoltaic modules 105, a first tie 120 can extend at the location of a side of each photovoltaic module. In particular, the sides of the photovoltaic modules 105 are aligned and parallel to the first tie 120.

In some embodiments, such as those shown in FIGS. 1, 9, 10 and 11, at least one photovoltaic module 105 is bifacial.

FIG. 1 shows the system 100 comprising a plurality of photovoltaic modules 105, each photovoltaic module 105 being fixed to a first tie 120 being held taut between the two posts, 110 and 111. In addition, in FIG. 1, the rectangular photovoltaic modules 105 are installed in “portrait” mode.

FIG. 1 shows each post, 110 and 111, comprising at least one primary securing means 115. Each primary securing means 115 allows the tie 120 to be secured to each post, 110 and 111. In particular, the collaboration between the primary securing means 115 applies longitudinal tension to the first tie 120. In other words, the tie 120 is subjected to a longitudinal tension generated by the securing of the tie 120 to each post, 110 and 111, by the primary securing means 115. It is noted, in FIG. 1, that such a tension is shown at the location of the two posts, 110 and 111, by two diverging dashed arrows.

In some embodiments, such as that shown in FIG. 1, a tie 120 is a cable. In the photovoltaic system 100, when the tie 120 is a cable, a discrete tension is applied along the taut cable. In some variants, the tie 120 is a chain, corresponding to a series of rings that are interlaced and secured to each other. In these variants, when the chain is held taut between two posts, 110 and 111, the rings exert a tension on each other corresponding to a discrete tension along the chain. A tie 120 is, for example, made of metal or a metallic alloy. Preferably, the tie 120 is suitable for withstanding environmental constraints imposed by the installation site, for example, agricultural land.

In some embodiments, the fixing means 125 for fixing the photovoltaic module 105 to a tie 120 comprises a housing at least partially enclosing the tie 120. In other words, the fixing means 125 has at least one dimension larger than a dimension of the tie 120. For example, when the fixing means 125 comprises a hook-shaped housing and the tie 120 is a cable comparable to a tapered cylinder, the housing delimited by the curve of the hook has an inner dimension larger than the diameter of the cable. A fixing means 125 keeps the photovoltaic module 105 on the first tie 120 held taut, making it possible, in particular, to suspend the photovoltaic module 105 on the first tie 120. Such a fixing means 125 is therefore comparable to a suspension means.

In some embodiments, the fixing means 125 traverses at least partially the first tie 120. For example:
passages, able to receive at least one fixing means 125, are present in the thickness of the tie 120 and formed during the design of the tie 120; such a tie 120 is, for example, a chain or cable having passages comparable to bores;
when the tie 120 is a specific cable, the separation between the wires making up such a cable is realised so as to form the passages for the fixing means 125;
the tie 120 is pierced when the fixing means 125 is installed in order to form passages.

FIG. 22 shows an embodiment of a photovoltaic system 600 that is the subject of the invention. It is noted that, in FIG. 22, the posts are not shown.

In some embodiments, such as that shown in FIG. 22, the tie is, for example, a chain 123 having links that can be seen in FIG. 22-a2). In these embodiments, the fixing means 125 for fixing the photovoltaic module 105 to a tie 123 comprises, for example, a bolt 128 passing through the hollow space of a link and fixed to the photovoltaic module 105, as shown in FIG. 22-a1). In other words, in these embodiments the fixing means 125 traverses at least partially the first tie 123.

In some variants (not shown), the fixing means 125 is incorporated into a tie 120. For example, the tie 120 comprises securing clips, the clips being fixed on the tie 120 and configured to attach the photovoltaic module 105.

In some embodiments, such as that shown in FIG. 1, the photovoltaic system 100 also comprises:
for each post, 110 and 111, a secondary securing means 116 for securing a second flexible tie 121 to the posts, 110 and 111; the collaboration between the secondary securing means 116 applying longitudinal tension to the second tie 121, and
the second flexible tie 121 being held taut between the two posts, 110 and 111.

In these embodiments, the first tie 120 and the second tie 121 are secured to two different parts of the photovoltaic module 105 by, respectively, a fixing means 125 and another fixing means. In these embodiments, the fixing means 125 corresponds to a primary fixing means 125 and the other fixing means corresponds to a secondary fixing means. Such a secondary fixing means comprises, for example, a housing at least partially enclosing the second tie 121. For example, the first tie 120 and the second tie 121 are secured respectively in the upper portion and lower portion of the photovoltaic module 105. In other words, the first tie 120 is arranged above the second tie 121.

The embodiments, variants and characteristics mentioned previously and in the rest of the description for the first tie 120 can also be transposed to the second tie 121. It is noted that the first tie 120 and the second tie 121 can be similar or different.

The embodiments, variants and characteristics mentioned previously and in the rest of the description for the primary securing means 115 can also be transposed to the secondary securing means 116. It is noted that the primary securing means 115 and the secondary securing means 116 can be similar or different.

In some embodiments, such as those shown in FIGS. 1 and 2, the system 100 and the two variants 100-a) and 100-b) also comprise at least one anchoring means 112 for anchoring at least one tie, 120 and/or 121, in an installation ground 101. For example, this anchoring means is a stake which comprises a securing means for securing the end of the tie, 120 and/or 121.

It is noted, in these embodiments, that the collaboration between said anchoring means and the securing means, 115 and/or 116, applies supplementary longitudinal tension to the tie, 120 and/or 121.

In these embodiments, such as those shown in FIGS. 1 and 2-a), when the system 100 comprises a first tie 120 and a second tie 121, the ends of each tie, 120 and 121, are connected in twos by the same anchoring means.

FIG. 2-a) shows a system 100-a) having anchoring means 112 referred to as “aligned”, i.e. aligned relative to the straight line passing through the two posts, 110 and 111, referred to as the “line of posts”.

FIG. 2-b) shows a system 100-b) which comprises an anchoring means for each end of the two ties, 120 and 121. In FIG. 2-b), the system 100-b) has anchoring means 112 referred to as “laterally offset”, i.e. offset relative to the line of posts. In other words, these anchoring means 112 are offset laterally on both sides of the line of posts, thereby increasing the resistance of the system 100-b) when it is subjected to a crosswind.

It is noted that, according to the mechanical stresses applied to the system 100, other anchoring means 112, with or without lateral offsetting on both sides of the line of posts, can be added.

In some embodiments, such as those shown in FIGS. 3 and 4, at least one post, 110 and/or 111, comprises a securing means, 115 and/or 116, for securing a tie, 120 and/or 121.

It is noted that, in FIG. 3, the primary securing means 115 is a through-opening, which can be seen in 3-a2) and 3-a3), into which the tie 120, such as a cable, is inserted. Such an opening 115 is comparable to a bore, i.e. an opening forming a tapered cylinder into which the cable is inserted. Preferably, the generatrix of this tapered cylinder is perpendicular to the axis Z1 of the post 110. Such a bore has a similar function to the eye of a needle. It can be seen, in FIG. 3, that the secondary securing means 116 is also a through-opening.

It is noted that the primary securing means 115 is compatible with a variety of post profiles, as shown in FIG. 8.

For example, in FIG. 8, the post has different profiles:
C-shaped in 8-b), 8-e) and 8-g),
cross-shaped in 8-i) and 8-o),
H-shaped in 8-j),
rectangle-shaped, even square-shaped, in 8-k), 8-m) and 8-n), and
triangle-shaped in 8-l).

In particular, in FIG. 8 and for variants 8-a), 8-b), 8-c), 8-d), 8-e), 8-f), 8-g), 8-h), 8-k), 8-l), 8-m) and 8-n), the post comprises a longitudinal void, i.e. along the axis Z1 of the post 110. In other words, the post is not considered solid, but as free of material along the axis Z1.

In FIG. 8, the posts shown can be obtained by folding, extrusion or any other production method known to the person skilled in the art.

It is noted, in FIG. 4, that a primary securing means 115 comprises a housing delimited by a hook. It can be seen, in FIG. 4, that the post 110 has a longitudinal surface comprising an axis preferably parallel to the axis Z1 of the post. In addition, in FIG. 4 the hook is arranged:
on the longitudinal surface of the post 110, as shown in 4-a), such that the tie 120 is in contact with this longitudinal surface, or
set back from the longitudinal surface of the post, and closer to the axis Z1 of the post 110, as shown in 4-b).

In some embodiments, such as those shown in FIGS. 3 and 4, a post 110 comprises several primary securing means 115. It is noted that the primary securing means are arranged at different heights along an axis parallel to the axis Z1 of the post 110 so as to have access to a plurality of heights of the first tie 120.

In some embodiments, such as those shown in FIGS. 3 and 4, when a first tie 120 and a second tie 121 are comprised in the photovoltaic system, a post 110 comprises several secondary securing means 116. It is noted that the secondary securing means are arranged at different heights along an axis parallel to the axis Z1 of the post 110 so as to access a plurality of heights of the second tie 121. In particular, the height for fixing the second tie 121 is dependent on the height for fixing the first tie 120.

Preferably, a post 110 comprises several primary securing means 115 and several secondary securing means 116.

In this way, the flexibility of the photovoltaic system with regard to the installation and the determination of the height of the ties, 120 and 121, is improved since the positioning of the ties, 120 and 121, is easy and adaptable according to the separation requirement of the ties, 120 and 121.

Additionally, when a system comprises:
two modules, one above the other, respectively fixed to a first tie 120 and to a second tie 121, the first tie 120 and the second tie 121 being separate, and
two posts 110 which comprise several primary securing means 115, such a system makes it possible to handle different installation site slopes while maintaining a substantially constant separation between the two modules.

It is noted that the primary securing means 115 associated to each post can be identical or different. In addition, the secondary securing means 116 associated to each post can be identical or different.

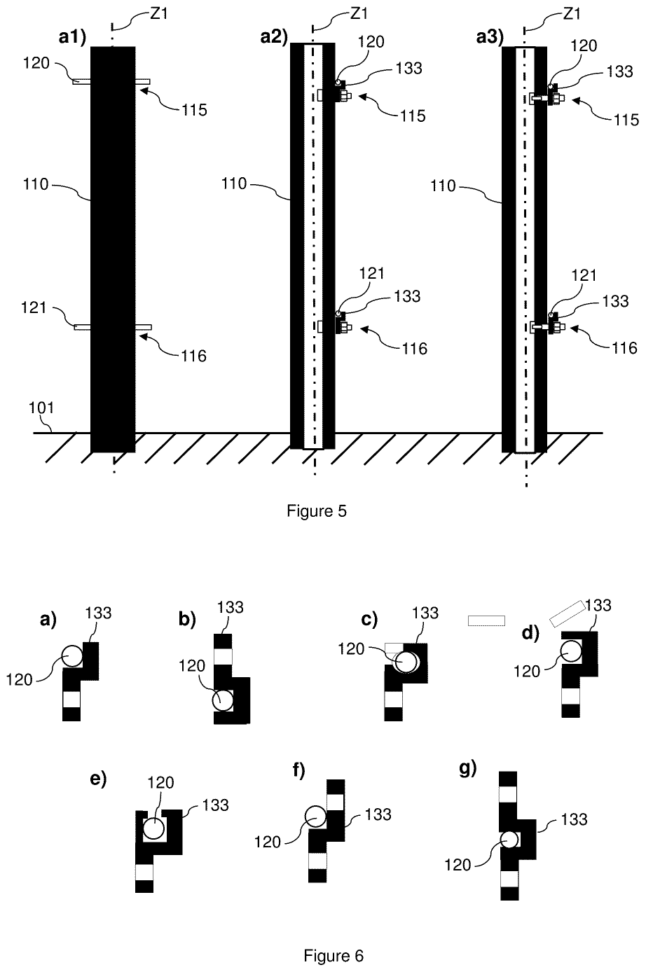

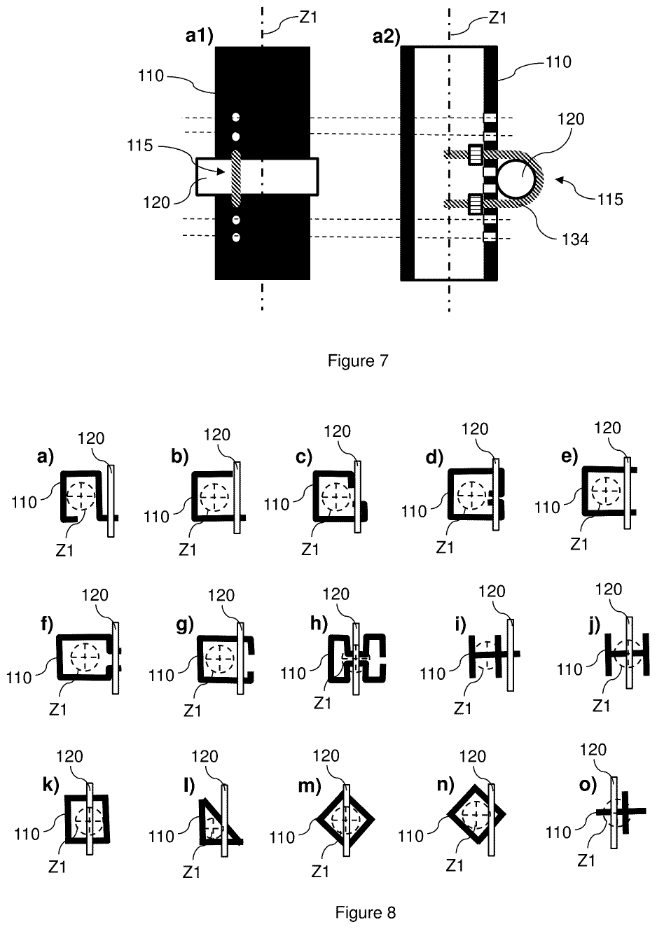

In some embodiments, such as those shown in FIGS. 5 and 7, at least one primary securing means 115 comprises an intermediate part, 133 or 134, for securing a post 110 to a first tie 120.

It is noted that, when the primary securing means 115 comprises an intermediate part 133, such a primary securing means 115 must comprise an assembly means for assembling the intermediate part, 133 or 134, to the post 110.

FIG. 5 shows the intermediate part 133 of the primary securing means 115, configured to:
be secured to the outer surface of the post 110, and
form an elbow, hook or any other shape defining a housing for inserting the first tie 120.

In particular, in FIG. 5-a3), the intermediate part 133 and the post respectively comprise a bore allowing the intermediate part 133 to be assembled to the post 110. For example, a nut and bolt assembly makes it possible to assemble the intermediate part 133 to the post 110. More specifically, the body of the bolt is inserted into the bore of the intermediate part and into the bore of the post in order to ensure the secure attachment. It is noted that the assembly consisting of the bore of the post 110, the bore of the intermediate part 133 and the bolt forms a means for assembling the intermediate part 133 to the post 110.

FIG. 6 shows seven embodiments, 6-a), 6-b), 6-c), 6-d), 6-e), 6-f) and 6-g), of an intermediate part 133. It is noted that, in these embodiments, the intermediate part comprises a bore. In variants 6-a), 6-b), 6-d), 6-f) and 6-g), the intermediate securing part 133 forms at least one elbow for holding the first tie 120. In variants 6-c) and 6-e), the intermediate securing part 133 forms a hook.

FIG. 7 shows the intermediate part 134 of the primary securing means 115, configured to:
be secured to an inner surface of the post 110, and
enclose the first tie 120 as shown in FIG. 7-a1) and 7-a2).

In particular, it is noted that the intermediate part 134 is U-shaped, as shown in FIG. 7-a2). It can be seen that the two arms of the U formed by the intermediate part are partially inserted into two bores in the post 110. In addition, these two arms are preferably threaded in order to enable bolting, carried out with nuts, to an inner surface of the post 110. It is noted that the assembly, consisting of bores of the post 110, the thread of the arms of the U formed by the intermediate part 134 and bolts, forms a means for assembling the intermediate part 134 to the post 110.

In some embodiments (not shown), the arms of the U formed by the intermediate part 134 have different lengths. For example, one arm is shorter than the other arm so as to facilitate the positioning and tightening of the first tie 120 when installing the photovoltaic system.

It is noted that, in FIG. 5, at least one secondary securing means 116 comprises a securing part for securing a post 110 and/or 111 to a second tie 121. Such a securing part has the same variants as those mentioned for the securing part 133 comprised in the primary securing means 115.

In some embodiments, such as those shown in FIGS. 9 to 21, a fixing means 125 for fixing the photovoltaic module 105 to the tie comprises a fixing mount 126 for fixing the photovoltaic module 105. Preferably, the fixing mount 126 is comprised at least partially of material reflecting light radiation.

In some embodiments, such as those shown in FIGS. 9, 10 and 11, at least one rectangular photovoltaic module 105 is fixed by a fixing mount 126 to a first tie 120. It is noted that such a mount is arranged on a long side of the photovoltaic module 105, such a photovoltaic module 105 is therefore installed in “landscape” mode.

In some embodiments, such as those shown in FIGS. 9, 10 and 11, the fixing mount 126 delimits a face of the photovoltaic module 105. In particular, when the photovoltaic module is rectangular, the fixing mount extends, for example, at least partially over at least one of the sides of the photovoltaic module 105.

In some embodiments, such as that shown in FIG. 9, the fixing mount 126 comprised in the fixing means 125 comprises at least two fixing hooks 201 for fixing to the first tie 120. For example, when the photovoltaic module 105 is installed in “landscape” mode, each fixing hook 201 is arranged respectively between the axis Z2 and each short side.

FIG. 9 shows the fixing mount 126 also comprising two other hooks 202, referred to as secondary fixing hooks 202 for fixing to the second tie 121. Note that the arrangements of each hook, 201 and 202, can be varied according to the requirements of the installation of the system 200. For example, the hooks 201 and secondary hooks 202 are offset with respect to one another in the plane comprising the face of the photovoltaic module 105.

In some embodiments, such as that shown in FIG. 10, the fixing mount 126 comprised in the fixing means 125 comprises at least two fixing hooks 301 for fixing to the first tie 120. For example, at least one side of a hook 301 is aligned to a side of the fixing mount 126. It is noted that the fixing hooks 301 of the system 300 have at least one dimension larger than the dimension of the fixing hooks 201 of the system 200. In particular, a fixing hook 301 of the system 300 covers the first tie 120 longitudinally to a greater extent than a fixing hook 201 of the system 200.

FIG. 10 shows the fixing mount 126 also comprising another hook 302, referred to as secondary fixing hook 302 for fixing to the second tie 121. Note that the arrangements of each hook, 301 and 302, can be varied according to the requirements of the installation of the system 300. For example, the hooks 301 and secondary hook 302 are offset with respect to one another in the plane comprising the face of the photovoltaic module 105.

Note that, in FIGS. 9 and 10, the number and length of the hooks, 201, 202, 301 and 302, are variable and adaptable according to the requirements of the installation of the systems 200 and 300.

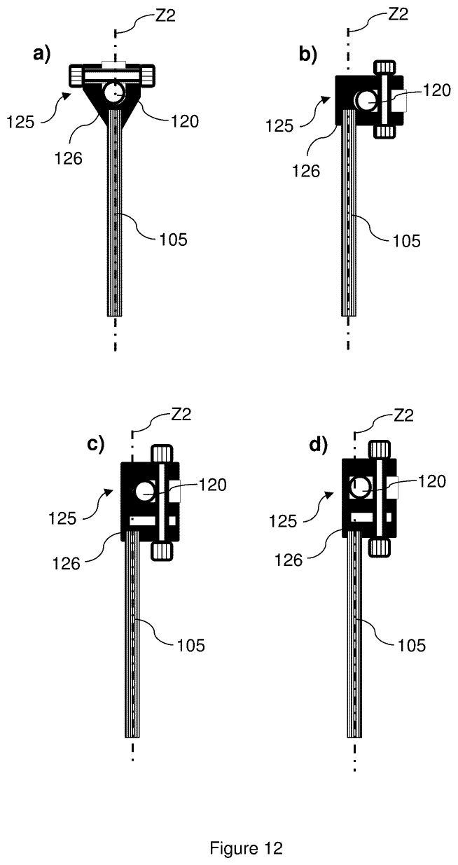

In some embodiments, such as those shown in FIGS. 12, 13 and 14, a fixing mount 126 comprises a housing at least partially enclosing the first tie 120.

In some embodiments, such as those shown in FIG. 12, in particular in 12-a), 12-b), 12-c) and 12-d), the first tie 120 is immobilised in the housing of the fixing mount 126 by an assembly of a bolt and two nuts. In particular, the fixing mount 126 comprises two bores outside the housing, configured to receive the fixing bolt. It is noted that, when the first tie 120 is in the housing of the fixing mount 126, such a first tie 120 abuts against a portion of the body of the bolt, thereby preventing the dislodging of the tie 120, and therefore maintaining the fixing of the photovoltaic module 105 to the first tie 120.

FIG. 12 shows, in 12-a), the fixing mount comprising an axial opening, in particular oriented along axis Z2 when the photovoltaic module 105 is fixed to the tie 120, suitable for the insertion of the tie 120 in the housing. In some variants, in 12-b), 12-c) and 12-d), the fixing mount comprises a side opening, in particular oriented perpendicular to axis Z2 when the photovoltaic module 105 is fixed to the tie 120, suitable for the insertion of the tie 120 in the housing.

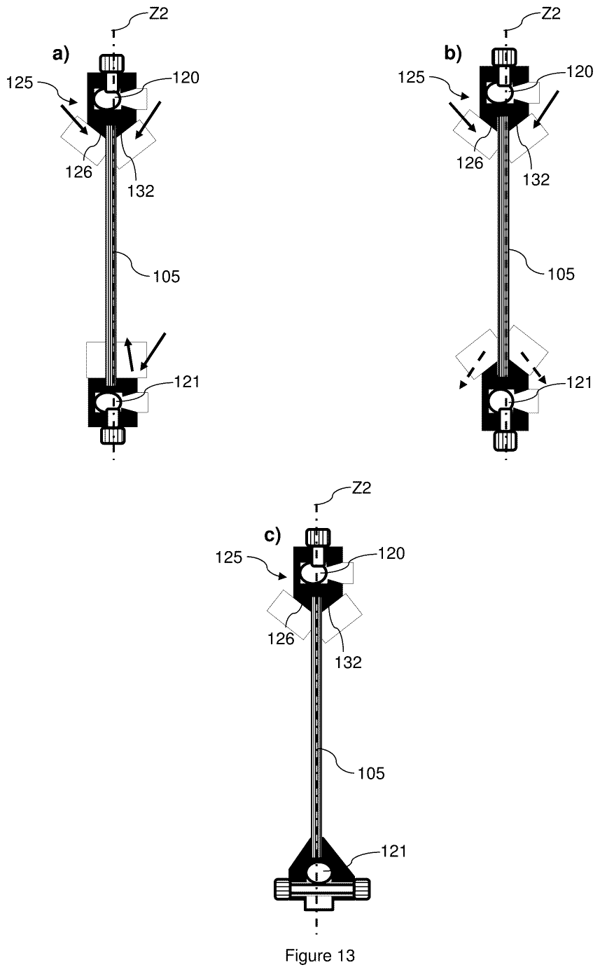

In some embodiments, such as those shown in FIG. 13, the first tie 120 is immobilised in the housing of the fixing mount 126 by a nut and bolt assembly. In particular, the fixing mount 126 comprises a thread, communicating with the housing and configured to receive the fixing bolt. It is noted that, when the first tie 120 is in the housing of the fixing mount 126, such a first tie 120 is clamped by the flat end of the bolt, thereby preventing the dislodging of the tie 120, and therefore maintaining the fixing of the photovoltaic module 105 to the first tie 120.

FIG. 13 shows the fixing means 125, and in particular the fixing mount fixation 126, with at least one portion forming a bevel 132 oriented towards at least one face of the photovoltaic module 105, for example an active face. It is noted that, when the module 105 is bifacial, the bevel 132 is preferably oriented towards the two active faces of the photovoltaic module 105.

In FIG. 13, the light radiation is shown by a solid arrow, and a flow of water or dust is shown by a dashed arrow. 13-a), 13-b) and 13-c) show the fixing mount 126 with a bevelled upper portion 132, this upper portion being in the upper portion of the photovoltaic system, such a bevel being oriented towards the active face of the photovoltaic module 105 allowing a greater amount of light radiation to pass through. 13-b) and 13-c) show the fixing mount 126 with a bevelled lower portion, this lower portion being in the lower portion of the photovoltaic system, such a bevel being oriented towards the active face of the photovoltaic module 105 allowing water and dirt to flow away.

In other words, in certain embodiments the portions of the mount 126 forming bevels are located around the active face of the module 105 in the upper and/or lower portion and/or on the sides delimited by the mount 126.

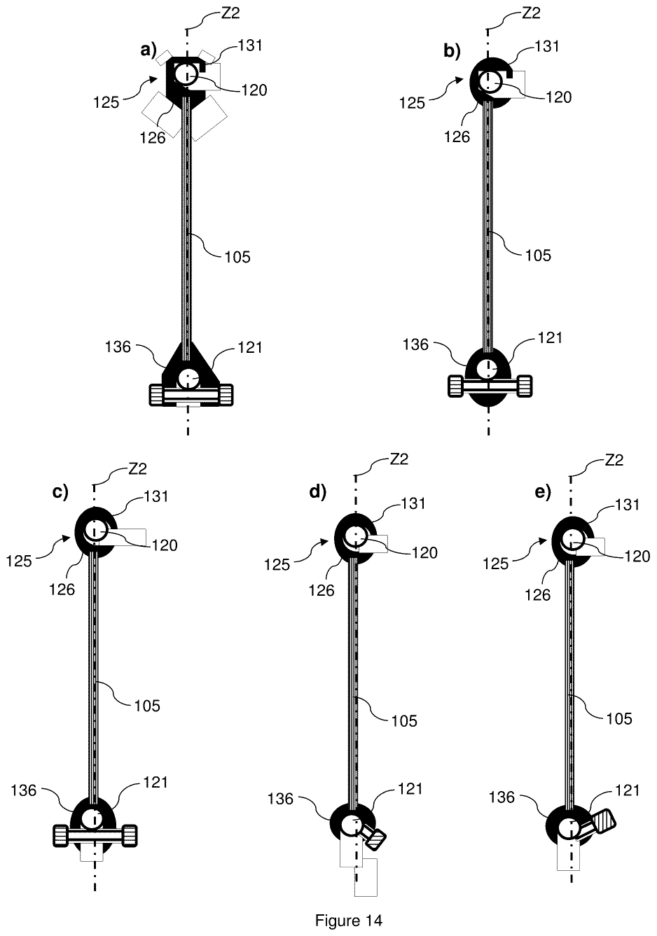

In some embodiments, such as that shown in FIG. 14, the securing means 125 comprises a fixing hook 131. In particular, in FIG. 14 the fixing hook 131 delimits the housing 126 and is comprised in the fixing mount 126 of the photovoltaic module 105.

In these embodiments, shown in FIG. 14, a second tie 121 is also fixed to the photovoltaic module 105 by means of a second fixing mount 136 comprised in a secondary fixing means. In other words, the first tie 120 and the second tie 121 are secured to two different parts of the photovoltaic module 105 by, respectively, a primary fixing means 125 and a secondary fixing means. Such a secondary fixing means also comprises a housing at least partially enclosing the second tie 121. In particular, the first tie 120 and the second tie 121 are fixed vertically and respectively above and below the active face of the photovoltaic module 105. In other words, the first tie 120 is arranged above the second tie 121. It is noted that such a secondary fixing means for fixing the tie 121 comprises, for example, a bolt comprising two nuts, as shown in 14-a), 14-b) and 14-c), configured to flatten the tie 121 in the housing of the secondary fixing means. In some variants, such a secondary fixing means for fixing the tie 121 comprises, for example, a bolt and a nut, as shown in 14-d) and 14-e), configured to flatten the tie 121 in the housing of the secondary fixing means. Thus, such a secondary fixing means prevents the photovoltaic module 105 from becoming detached not only from the second tie 121, but also from the first tie 120 by maintaining contact between the first tie 120 and the upper inner curve of the hook 131 of the primary fixing means 125. In addition, the lateral movement of the photovoltaic module 105, such as sliding along the first tie 120, is prevented.

FIG. 14 shows, in 14-a), 14-c), 14-d) and 14-e), the second fixing mount 136 comprising an opening suitable for the insertion of the tie 121 in the housing.

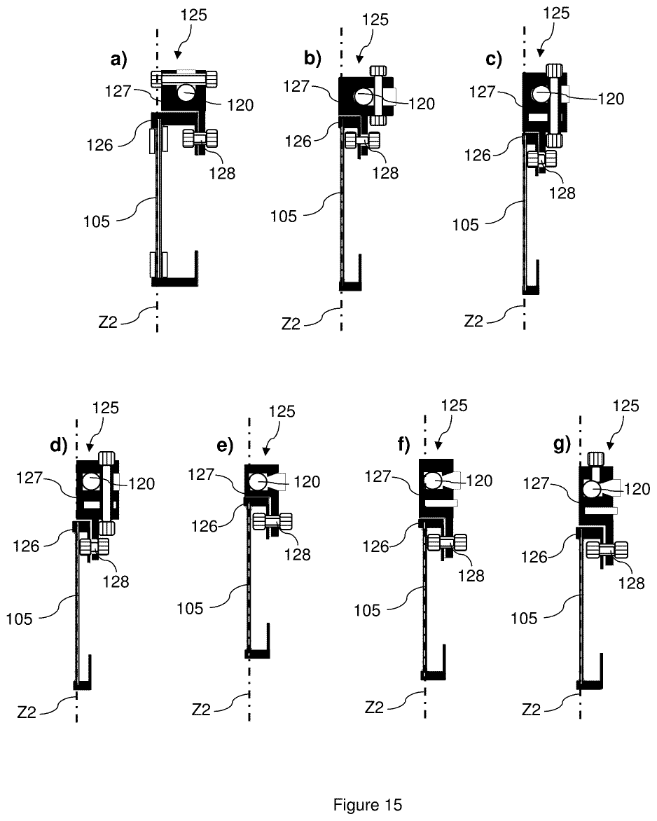

In some embodiments, such as those shown in FIGS. 15 to 18, a fixing means 125 for fixing the photovoltaic module 105 to the first tie 120 also comprises an intermediate fixing element 127.

FIG. 15 shows an intermediate fixing means 127 separate from the fixing mount 126. In particular, the intermediate fixing means 127 and the fixing mount 126 are connected by a connecting means 128. For example, such a connecting means 128 comprises a bolt comprising two nuts. Note that, in this example, the assembly consisting of a bore of the intermediate fixing means 127, a bore of the fixing mount 126 and the bolt forms the connecting means 128.

In FIG. 15, in 15-a), 15-b), 15-c), 15-d), 15-e), 15-f) and 15-g), the fixing mount 126 corresponds, for example, to the frame of the photovoltaic module 105. For example, the frame of the photovoltaic module 105 is a standard frame known to the person skilled in the art.

It is noted, in FIG. 15, that, for a photovoltaic module 105 having a standard frame 126, a plurality of intermediate fixing means 127 is used. In particular, the fixing means 127 is a part comprising a housing at least partially enclosing the first tie 120. Such a part comprises an opening suitable for the insertion of the tie 120 in the housing. The variants mentioned previously for immobilising the first tie 120 in the housing of a fixing means 125 are also applicable to the intermediate fixing means 127.

FIG. 15 shows the frame 126 and the intermediate fixing means 127 connected by a connecting means 128. In particular, the connecting means 128 comprises a bolt and two nuts. The frame 126 and the intermediate fixing means 127 are pierced to allow the passage of the body of the bolt. When the frame 126 and the intermediate fixing means 127 are connected, the bolts of the connecting means 128 are tightened and respectively in contact with the frame 126 and the intermediate fixing means 127.

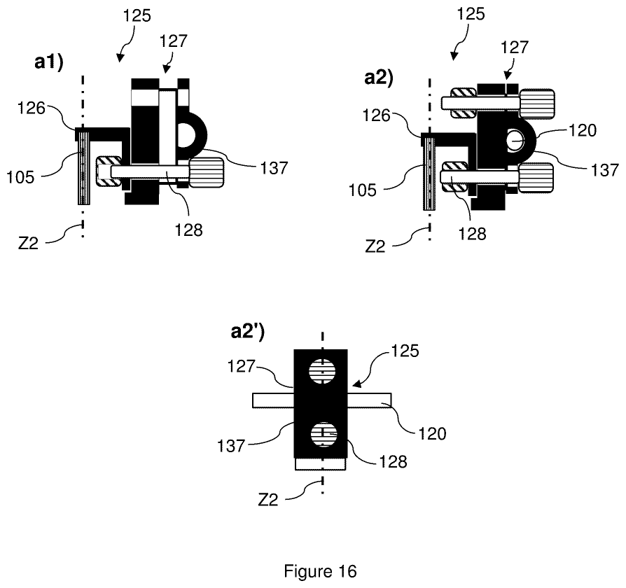

In some embodiments, such as that shown in FIG. 16, in 16-a1) and 16-a2), the intermediate fixing means 127 is in two parts:
a first part being configured to be fixed to the fixing mount 126 of the photovoltaic module 105, and
a second part being configured to enclose the first tie 120.

In these embodiments, the first tie 120 is immobilised between the first part and the second part.

Note, in FIG. 16-a1) and 16-a2), that:
the first part and the fixing mount 126 are pierced and fixed to each other by a connecting means 128 comprising, for example, a first bolt passing through each of the pierced parts, and
the second part is a clip 137 enclosing the first tie 120; such a clamp 137 is also pierced so as to be secured to the first part, pierced two times, by, for example, a second bolt passing through each of the pierced parts.

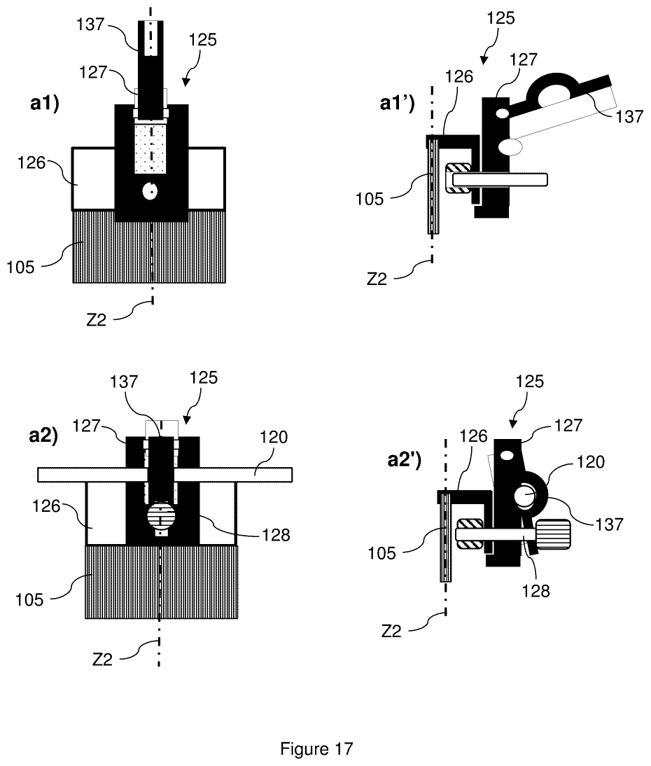

In other embodiments, such as that shown in FIG. 17, in 17-a1), 17-a1′), 17-a2) and 17-a2′), the intermediate fixing means 127 is in two parts connected by a pivoting shaft:
a first part being configured to be fixed to the fixing mount 126 of the photovoltaic module 105, and
a second part being configured to be secured to the first tie 120.

In these embodiments, the first tie 120 is immobilised between the first part and the second part. In addition, the pivoting shaft makes it possible to open or close the fixing means 125 along a pivot axis parallel to the longitudinal axis of the taut first tie 120.

Note, in FIG. 17, in particular in 17-a1′) and 17-a2′), that:
the first part and the fixing mount 126 are pierced and fixed to each other by a connecting means 128 comprising, for example, a first bolt passing through each of the pierced parts, and
the second part is a clip 137 enclosing the first tie 120; such a clamp 137 is connected to the first part by a pivoting shaft providing the link between the first part and the clamp 137. It is noted that, preferably, as can be seen in 17-a1), the clamp 137 comprises an opening aligned to the body of the bolt. Such an opening is configured to surround the bolt fixing the first part and the fixing mount 126. Preferably, the bolt is held in the opening of the clamp 137 by a tightened nut.

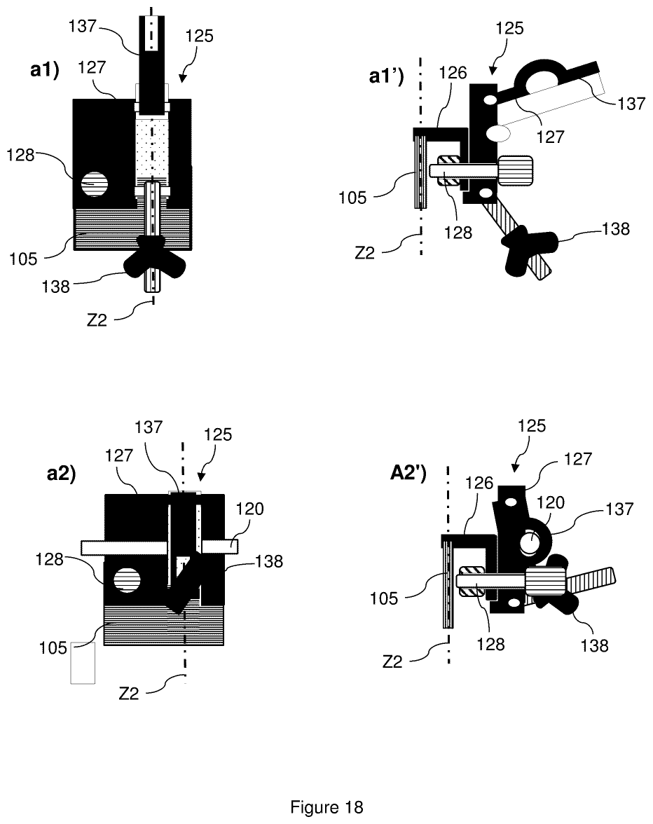

In some variants, such as the one shown in FIG. 18, the nut and bolt assembly fixing the first part to the fixing mount 126 of the photovoltaic module 105 is offset relative to the opening of the clamp 137 of the second part. 18-a1′) shows the intermediate fixing means 127 consisting of three connected parts:
a first part connected to the fixing mount 126 by a connecting means 128,
a second part being a clamp 137 and connected to the first part by a first pivoting shaft, and
a third part being a “wing screw” 138 and connected to the first part by a second pivoting shaft.

Preferably, the axis of the first pivoting shaft and the axis of the second pivoting shaft are parallel to each other, and are also parallel to the longitudinal axis of the taut first tie 120 and perpendicular to the axis Z2 of the module 105.

In these variants, when the first tie 120 is enclosed by the clamp 137 of the intermediate fixing means 127, the wing screw 138 is pivoted to be surrounded by the opening of the clamp 137 and tightened to maintain the cohesion and fixing of the assembly.

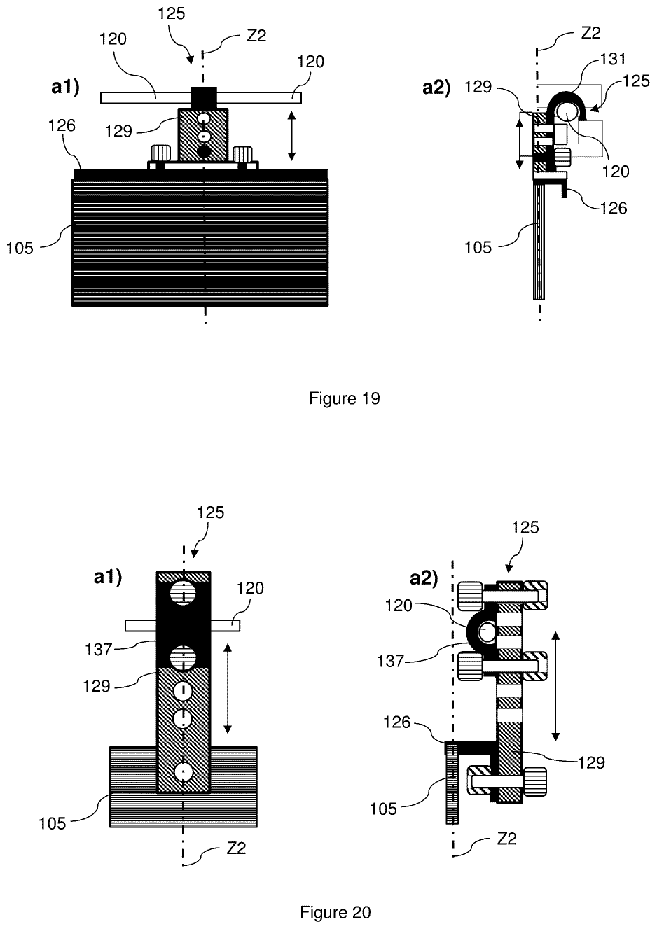

In some embodiments, such as those shown in FIGS. 19 to 21, a fixing means 125 for fixing the photovoltaic module 105 to the first tie 120 comprises an adjustment means 129. Such an adjustment means is configured to position at least one active face of the photovoltaic module 105 closer to or farther from the first tie 120 being held taut between the two posts. It is noted that, when the photovoltaic system comprises a second tie, such a fixing means 125 can also be used to position at least one active face of the photovoltaic module 105 closer to or farther from the second tie 121.

FIGS. 19 to 21 show the adjustment means 129 comprising an intermediate part that comprises a plurality of bores. Such bores allow the height of the photovoltaic module 105 relative to the first tie 120 to be adjusted.

FIG. 19 shows the intermediate part of the adjustment means 129 connected to:
a fixing hook 131 for fixing the fixing means 125 to the first tie 120, and
a photovoltaic module having a frame 126 of the fixing means 125, for example a standard frame.

In particular, in FIG. 19, the adjustment means 129 is arranged vertically above an active face of the photovoltaic module 105.

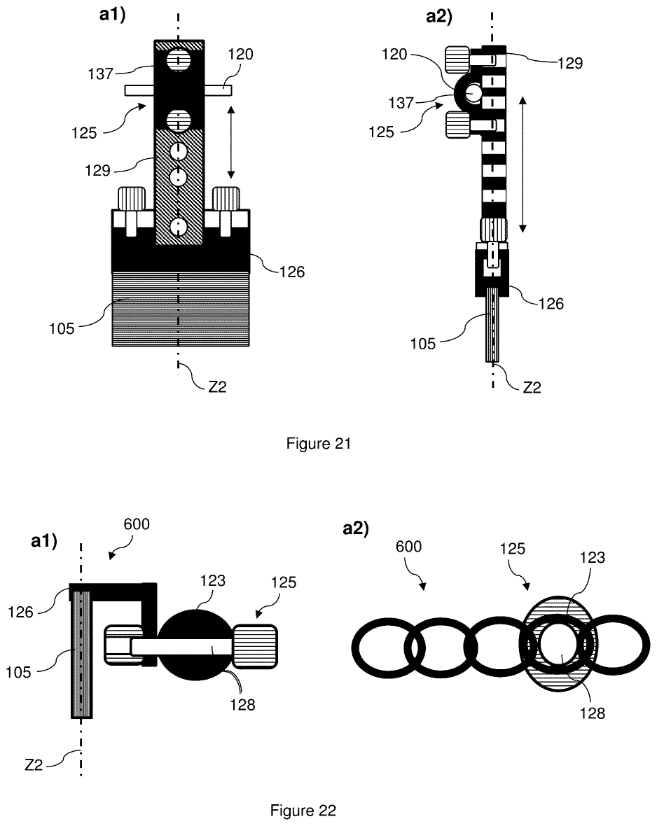

FIGS. 20 and 21 show the intermediate part of the adjustment means 129 connected to:
a fixing clamp 137 for fixing the fixing means 125 to the first tie 120, and
a photovoltaic module having a frame 126 of the fixing means 125, for example a standard frame.

FIG. 20 shows the adjustment means 129 arranged at the rear of an active face of the photovoltaic module 105. FIG. 21 shows the adjustment means 129 arranged vertically above an active face of the photovoltaic module 105.

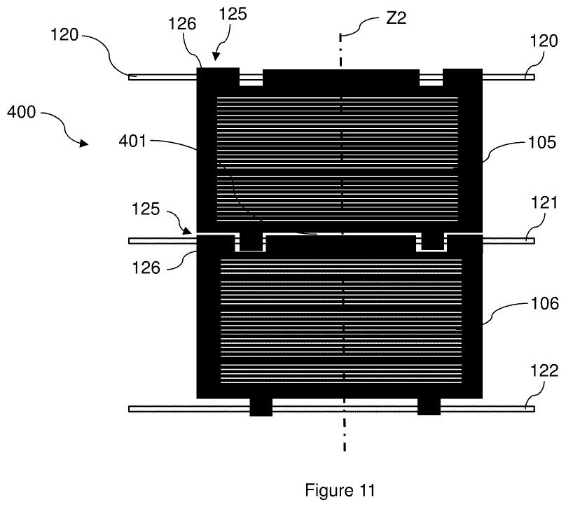

In some embodiments, such as that shown in FIG. 11, the system 400 comprises:
a first tie 120 and a second tie 121,
two photovoltaic modules, 105 and 106,
and, for each module, a fixing mount 126 delimiting one face of the photovoltaic module, 105 or 106.

FIG. 11 shows the photovoltaic module 105 fixed on a first tie 120 in the upper portion, and on a second tie 121 in the lower portion. It can also be seen that the photovoltaic module 106 is fixed on the second tie 121 in the upper portion, and on a third tie 122 in the lower portion. It is noted that the fixing of the photovoltaic module 106 on a third tie 122 in the lower portion allows greater verticality and stability.

It is noted that a fixing mount 126 of a photovoltaic module 105 also comprises an opening 401 partially surrounding the second tie 121. Such an opening corresponds to a portion of the fixing mount 126 free of materials. In addition, such an opening 401 is configured to receive a portion of the fixing mount 126 of the other photovoltaic module 106. Such a fixing mount 126, being a frame for example, fixes the photovoltaic module 106 to the tie 121. Note that the characteristics of the different embodiments and variants described above for the fixing means 125 and the fixing mount 126 are applicable to the embodiment shown in FIG. 11.

In other words, in FIG. 11, the opening of the fixing mount 126 of the photovoltaic module 105 is delimited so as to allow the passage of the portion of the fixing mount 126 of the photovoltaic module 106. For example, the fixing mount 126 of the photovoltaic module 105 is fixed to the second tie 121 by two different horizontal portions. It can be seen that these two portions delimit the opening 401 of the fixing mount 126 of the photovoltaic module 105. In particular, between these two portions for fixing the module 105 to the second tie 121 a portion of the fixing mount 126 of the other photovoltaic module 106 is inserted. For example, as shown in FIG. 11, such a portion for fixing the photovoltaic module 106 is solid and extends along the second tie. For example:
the two portions for fixing the module 105 to the second tie 121 comprise a fixing hook, and
the portion for fixing the photovoltaic module 106 to the second tie 121 also comprises a fixing hook.

In some embodiments, such as that shown in FIG. 11, the opening 401 of the fixing mount 126 for fixing the photovoltaic module 105 delimits a shape complementary to the fixing mount 126 for fixing the photovoltaic module 106. Such a complementarity allows the fixing mount 126 of the photovoltaic module 106 to be embedded in the opening 401 of the fixing mount 126 of the photovoltaic module 105.

FIG. 11 shows the fixing mount 126 of the photovoltaic module 105 comprising a plurality of openings: in particular two openings in the upper portion and three openings in the lower portion, including opening 401. In general, in this embodiment, the shape of the fixing mount 126 of the photovoltaic module 105 is configured to:
allow this module 105 to be fixed to the first tie 120 and to the second tie 121,
by having at least one opening, allow the second tie 121 to be shared with the fixing mount 126 of the other photovoltaic module 106, and
optionally, share the first tie 120 with a fixing mount of a third photovoltaic module arranged above the module 105.

In this embodiment, the mount 126 of the other photovoltaic module 106 comprises a number of openings similar to the mount 126 of the photovoltaic module 105. Such a mount has a shape providing a similar function to that mentioned previously for the fixing mount 126 of the photovoltaic module 105.

In some embodiments, such as that shown in FIG. 11, at least two photovoltaic modules, 105 and 106, are arranged vertically, one photovoltaic module 105 being arranged above the other photovoltaic module 106 in the installation configuration of the system 400. In particular, the two photovoltaic modules, 105 and 106, are installed in “landscape” mode.

In other words, all or part of the photovoltaic modules, 105 and 106, can be stackable in a modular way. “Stackable” means aligned vertically, preferably maximising the effective surface of the modules. This stacking is achieved, for example, by sharing the same tether cable 121 for two photovoltaic modules, 105 and 106. This sharing therefore assumes that the fixing means 125 for fixing each photovoltaic module, 105 and 106, to the cable 121 do not interfere with each other. This can be achieved in several ways.

One such way consists of ensuring that the fixing mount 126 of a photovoltaic module 105 is pierced to expose the cable 121, so as to allow the passage of the fixing mount 126 of another photovoltaic module 106 and the fixing of this other module 106 to the cable 121 thus exposed. One such way of achieving this stacking is compatible with using a fixing mount 126 corresponding to a frame, the frame 126 being comprised in the fixing means 125 and the frame 126 being pierced to allow the passage of a fixing means 125 of another photovoltaic module 106.

Another way consists of providing at least one space between two fixing means 125 of the same photovoltaic module 105, this space exposing the cable 121, such that the fixing mount 126 of another photovoltaic module 106 can be positioned in this space.

In some embodiments (not shown), the photovoltaic system comprises a plurality of photovoltaic modules 105 arranged vertically above one another, the number of modules being greater than two.

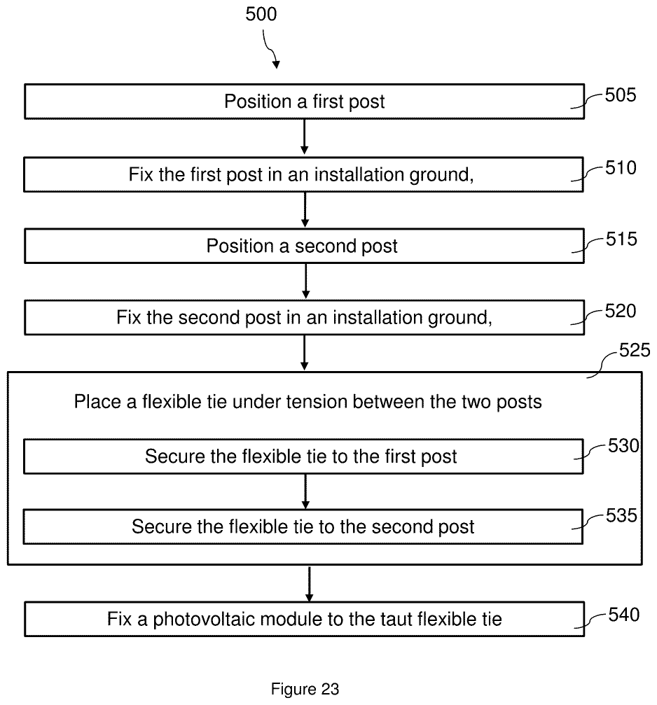

FIG. 23 shows a schematic view of an optional embodiment of the method 500 that is the subject of the present invention. The method 500 for installing a cable-supported vertical photovoltaic system comprises:
a step 505 of positioning a first post,
a step 510 of fixing the first post in an installation ground,
a step 515 of positioning a second post,
a step 520 of fixing the second post in an installation ground,
a step 525 of placing under tension at least one flexible tie between the two posts, comprising:
a step 530 of securing the flexible tie to the first post, and
a step 535 of securing the flexible tie to the second post, and
a step 540 of fixing a photovoltaic module to the taut flexible tie.

During the positioning steps, 505 and 515, each post is positioned so as to allow the subsequent fixing of a tie producing a tension.

During the step, 510 and 520, of fixing the posts, the fixings are configured to withstand certain mechanical stresses applied to the system, dependent in particular on the installation environment.

It is noted that the combination of the two steps, 530 and 535, of securing the tie to the first post and the second post carry out the tensioning of the tie when the system is installed.

During the step 540 of fixing a photovoltaic module, the contact between the photovoltaic module and the taut tie is established and immobilised so as to maintain the verticality of the system.

Preferably, the method 500 also comprises:
a step of placing under tension at least a second flexible tie between the two posts, comprising:
a step of securing the second flexible tie to the first post, and
a step of securing the second flexible tie to the second post, and
a step of fixing the photovoltaic module to the second taut flexible tie.

Preferably, the means of the devices 100, 200, 300, and 400, are configured to implement the steps of the method 500 and their embodiments as described above, and the method 500 and its different embodiments can be implemented by the means of the devices 100, 200, 300, and 400.

1. A vertical photovoltaic system comprising at least one photovoltaic module and two posts, which system is characterised in that it comprises at least:
for each post, a primary securing means for securing a first flexible tie to said post, the collaboration between the primary securing means applying longitudinal tension to the first tie,
the first flexible tie being held taut between the two posts, and
a fixing means for fixing the module to the first tie;
which also comprises:
for each post, a secondary securing means for securing a second flexible tie to said post, the collaboration between the secondary securing means applying longitudinal tension to the second tie, and
the second flexible tie being held taut between the two posts, the first tie and the second tie being secured to two different parts of the photovoltaic module.

2. The photovoltaic system according to claim 1, wherein the fixing means comprises a housing at least partially enclosing a first tie.

3. The photovoltaic system according to claim 1, wherein the fixing means traverses at least partially a first tie.

4. The photovoltaic system according to claim 1, wherein the module is rectangular and delimited by at least one side, and the tie extends at the location of this side.

5. The photovoltaic system according to claim 1, wherein a fixing means for fixing the photovoltaic module to the tie comprises a fixing mount for fixing the photovoltaic module.

6. The photovoltaic system according to claim 4, wherein a fixing means for fixing the photovoltaic module to the tie also comprises an intermediate fixing element separate from the fixing mount and connected to the fixing mount by a connecting means.

7. The photovoltaic system according to claim 5, which comprises:
at least a first tie and a second tie,
at least two photovoltaic modules, and
for each said module, a fixing mount delimiting one face of the photovoltaic module, the fixing mount for fixing a module also comprises at least one opening partially surrounding the tie and configured to receive the fixing mount for fixing the other photovoltaic module with this tie.

8. The photovoltaic system according to claim 1, wherein the fixing means has at least one portion forming a bevel oriented towards the active face of the photovoltaic module.

9. The photovoltaic system according to claim 1, wherein the fixing means comprises an adjustment means is configured to position at least one active face of the photovoltaic module closer to or farther from the tie being held taut between the two posts.

10. The photovoltaic system according to claim 1, wherein at least one fixing means comprises a fixing hook or a fixing clamp.

11. The photovoltaic system according to claim 1, which also comprises at least one anchoring means for anchoring at least one tie in an installation ground, the collaboration between said anchoring means and the securing means applies supplementary longitudinal tension to the tie.

12. The photovoltaic system according to claim 1, wherein at least one post comprises a said securing means for securing a tie.

13. The photovoltaic system according to claim 1, wherein at least one securing means comprises an intermediate part for securing a post to a tie.

14. A method for installing a cable-supported vertical photovoltaic system, comprising:
a step of positioning a first post, the first post being positioned vertically,
a step of fixing the first post in an installation ground,
a step of positioning a second post, the second post being positioned vertically,
a step of fixing the second post in an installation ground,
a step of placing under tension at least two flexible ties between the two posts, comprising:
a step of securing each said flexible tie to the first post, and
a step of securing each said flexible tie to the second post, and
a step of fixing a photovoltaic module to said taut flexible tie, the first tie and the second tie being secured to two different parts of the photovoltaic module.
